(19) United States
(12) Patent Application Publication
(10) Pub. No.: US 2026/0119518 A1
(43) Pub. Date: Apr. 30, 2026

(54) MEMORY ISOLATION OF AN IN-DATABASE VIRTUAL MACHINE USING MEMORY PROTECTION KEYS

(71) Applicant: Oracle International Corporation, Redwood Shores, CA (US)

(72) Inventors: Arash Kazemi Koohbanani, Zurich (CH); Alexander Ulrich, Freiburg (DE); Giacomo Fabris, Zurich (CH); Altin Alickaj, Zurich (CH); Ravi Shankar Thammaiah, Redwood Shores, CA (US); Vikramraj Sitpal, Redwood Shores, CA (US); Shubham Kumar, Belmont, CA (US)

(21) Appl. No.: 18/934,139

(22) Filed: Oct. 31, 2024

(51) Int. Cl. G06F 16/25; G06F 9/455

(52) U.S. Cl. CPC G06F 16/252; G06F 9/45558; G06F 2009/45583

(57) ABSTRACT

Disclosed herein are approaches to isolate the execution of an embedded programming language virtual machine (VM) in a multi-tenant database management system (DBMS). At least a portion of a shared memory area may be associated with a memory protection key. A VM embedded in a database process of a DBMS may initiate execution of a user program. Execution of the database process may transition to a privileged mode, which may enable access to the at least a portion of the shared memory area by the VM. The VM may access the at least a portion of the shared memory area. Execution of the database process may transition to an unprivileged mode and disable access to the shared memory area by the VM. Further, a signal handler may receive a signal from a DBMS, wherein the signal interrupts a VM executing a user program in a database process, and the signal handler executes in the database process. The signal handler may write, to a protection key rights register for user pages (PKRU register), a particular PKRU value associated with a particular access permission to a shared memory area of the DBMS. The signal handler may handle the signal and write, to the PKRU register, a runtime PKRU value. The runtime PKRU value may be associated with a runtime access permission to the shared memory area.

### TECHNICAL FIELD

The present disclosure relates to memory isolation a multi-tenant database management system.

### BACKGROUND

A multi-tenant database management system (DBMS) can host multiple logically isolated databases—each database owned by a different tenant—in a shared DBMS. For each tenant, users of different privilege levels can access data according to a set of access control rules for that tenant. In addition to enforcing each database's own access control rules, though, the multi-tenant DBMS needs to ensure that no tenant can access data from another tenant's logical database. Thus, the multi-tenant DBMS must maintain logical isolation of its databases.

A DBMS maintains a number of shared, central memory regions, such as a buffer cache. In a multi-tenant DBMS, these shared memory regions can contain data from multiple different logical databases and thus from multiple different tenants.

In a multi-tenant DBMS, each tenant cannot control the database workload (e.g., SQL queries or stored procedures) being executed by other tenants who share central memory areas. The integrity of the DBMS must be preserved no matter what workloads are being executed by individual tenants.

The DBMS allows execution of user-defined functions (UDF) and stored procedures (SP) written in a programming language such as PL/SQL or JavaScript, supported by a programming language virtual machine (VM) that is embedded in a database process. A new VM is allocated for each database process. A VM can just-in-time (JIT) compile user programs to machine code during execution. After executing a particular piece of code several times, a VM can compile the piece of code to native code and execute the native code instead. Consequently, because users provide the code interpreted by the VM, they can also influence the JIT compiler to emit particular instructions in native code. The possible instructions are, however, a limited set of the entire Instruction Set Architecture (ISA); the JIT compiler cannot be influenced to emit arbitrary instructions.

Speculative execution attacks such as Spectre leverage speculations like these occurring in the CPU to read data from regions of memory that should not be allowed. For example, the branch predictor could be trained to never fail a bound check on a particular index access. Then, an out-of-bound index is passed triggering the CPU to speculatively skip the bound check, resulting in an out-of-bounds memory access. If the out-of-bounds memory location belongs to another tenant of the DBMS, this access could result in a data leak.

It would be desirable to protect DBMS memory regions shared between multiple users or processes from speculative execution attacks and memory corruption during VM execution.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example of a computing environment, in an embodiment.

FIG. 2 is a sequence diagram showing an example of a process that takes place during the execution of a virtual machine, in an embodiment.

FIG. 3 is a sequence diagram that depicts an example process for signal handling with a virtual machine, in an embodiment.

FIG. 4 is a block diagram that illustrates a computer system upon which an embodiment of the invention may be implemented.

FIG. 5 is a block diagram of a basic software system that may be employed for controlling the operation of a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Disclosed herein are approaches to isolate the execution of an embedded programming language VM in a multi-tenant DBMS. The disclosed approaches modify the DBMS and VM to protect shared memory areas from speculative execution attacks. The disclosed approaches prohibit invalid access to critical shared memory areas during execution of user-provided stored procedures, thereby preventing violations of data confidentiality across privilege levels and across tenants due to speculative execution attacks.

The disclosed approaches leverage memory protection keys in userspace (MPK) as a hardware primitive to partition the virtual address space of a database process into multiple regions, with the ability to efficiently enable and disable a thread's access to individual memory areas. The operating system (OS) interface layer of the DBMS may be responsible for partitioning the virtual address space of a database process and managing the associated MPKs. The embedded VM may leverage these services to manage memory access during user program execution. Using MPK, the DBMS allows access to protected memory areas only while trusted code is executing. During execution of untrusted user programs, on the other hand, access to protected memory regions is disabled.

Applications may implement signal handlers to handle signals that interrupt the execution of user programs and other database processes. Because signal handlers may also need to access protected memory areas, different memory access privileges may be set for different signal handlers. For certain signal handlers involved with system-critical tasks, MPKs may be used to give those signal handlers read-write access permissions to protected memory areas.

### System Overview

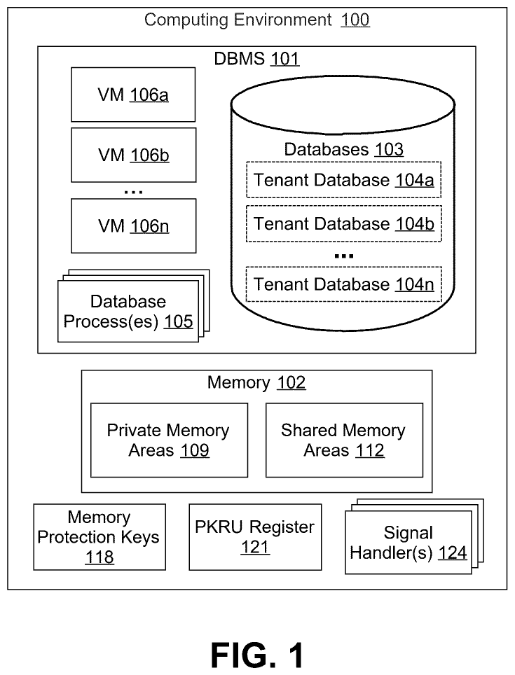

FIG. 1 is a block diagram that depicts an example of a computing environment 100, in an embodiment. The computing environment 100 comprises a DBMS 101 hosted thereon, memory 102, and various other components, some of which are discussed below.

The computing environment 100 may include a computing device, such as a server computer, that provides computing capabilities. For example, the computing device may be rack server such as a blade, a personal computer, a mainframe, a virtual computer, or other computing device. Alternatively, the computing environment 100 may employ multiple computing devices that are arranged in one or more server banks or computer banks. In one example, the computing devices may be located in a single installation. In another example, the computing devices for the computing environment 100 may be distributed among multiple different geographical locations. In one case, the computing environment 100 may include multiple computing devices that together may form a hosted computing resource or a grid computing resource. In addition, the computing environment 100 may operate as an elastic computing resource where the allotted capacity of computing-related resources, such as processing resources, network resources, and storage resources, may vary over time. In other examples, the computing environment 100 may include or be operated as one or more virtualized computer instances that may be executed to perform the functionality that is described herein.

The DBMS 101, such as a relational DBMS (RDBMS), is a multi-tenant DBMS. The DBMS 101 comprises a database server instance, for example, running in the computing environment 100. The DBMS 101 manages a number logically isolated tenant databases 103a, 103b, . . . , 103n (“tenant database(s) 103”). Each of these tenant databases 103 is associated with one of a plurality of tenants of the multi-tenant DBMS 101. The DBMS 101 may run various database processes that implement various tasks for the tenants of the DBMS 101. Programming language virtual machine (VMs) 106a, 106b, . . . , 106n (“VM(s) 106”) embedded in the database processes 105 support execution of user-defined functions and stored procedures on behalf of individual tenants.

The memory 102 comprises private memory areas 109 and shared memory areas 112. Using a VM 106, a tenant can access a private memory area 109 and the shared memory areas 112. A tenant's private memory area 109 may be accessible only by database processes 105 on behalf of that tenant. The shared memory areas 112, though, may be accessible, at least in part, to all tenants of the DBMS 101. Both a tenant's private memory area 109 and the shared memory areas 112 may contain data from that tenant's own tenant database 103. In the shared memory areas 112, a tenant may only access data from its own tenant database 103, subject to that tenant database's 103 own access control rules. A tenant's access to the shared memory areas 112 via a VM 106 may be limited as described below.

A VM 106 may be allocated for each database process 105 of the DBMS 101. The VM 106 may use a JIT compiler to compile user-defined programs during the VM's 106 execution. The instructions that the VM 106 may emit during execution of a user-defined program are a limited set of the ISA. During execution of a user-defined program, the VM 106 may manage memory access in collaboration with the OS interface layer of the DBMS 101.

The shared memory areas 112 may include the system global area (SGA), which may comprise, for example, a database buffer cache, a redo log buffer, a result cache, and various memory pools. When shared memory areas 112 are allocated during initialization of the DBMS 101, they may be tagged with a newly created MPK 118. If the shared memory areas 112 are fixed in size, they are tagged once after allocation. Otherwise, whenever additional memory is allocated to the shared memory areas 112, the same MPK 118 may be used to tag the newly allocated memory in the shared memory areas 112.

MPKs 118 are a feature of some CPUs that can be used to tag a region of memory with a specific key. During thread execution, a per-thread public key rights register for user pages (PKRU register) 121 stores the access permissions for each MPK 118. A thread can disable access to a tagged memory region by writing the appropriate mask to the PKRU register 121. The PKRU register 121 may be updated using the WRPKRU instruction (to read or write to the PKRU register 121). Because WRPKRU is a serializing instruction, it blocks possible speculations from happening within the tagged memory regions.

### Modes of Operation

VM 106 execution may include two modes of operation: privileged mode and unprivileged mode. In privileged mode, access to the shared memory areas is allowed, and the PKRU register's 121 permission bits are appropriately set. In unprivileged mode, access to the shared memory areas 112 is disabled. Before the execution of the VM 106 or after the destruction of the VM 106, the DBMS 101 can execute in either privileged mode or unprivileged mode.

Each entry point to the VM 106 may include a transition that sets execution of the database process 105 to unprivileged mode. When the VM 106 is exited, the epilogue of the entry point may include a transition to revert execution to privileged mode. That way, VM 106 execution will be in unprivileged mode and access to the shared memory areas 112, speculative or not, will not be allowed.

While the VM 106 executes user programs, the implementation of the VM 106 itself may need to access the shared memory areas 112 or to call a DBMS 101 function that entails accessing the shared memory areas 112. For example, the VM 106 may need to allocate memory from the DBMS 101 OS interface layer. In such cases, execution may be temporarily set to privileged mode for the duration of a short section of trusted code in the implementation of the VM 106 that performs the relevant task.

### Transitions Between Modes of Operation

While transitions to and from privileged mode are cheap, they do have some overhead. To minimize the duration in which privileged mode is enabled while also minimizing the performance overhead of the transitions between modes, two transition mechanisms may be used for different levels of granularity.

In fine-grained transitions, individual memory reads/writes and individual function calls to DBMS 101 functions may be instrumented to temporarily transition to privileged mode. Fine-grained transitions may be selectively performed based on code implementations in the implementation of the VM 106. Fine-grained transitions may be used by default. Using fine-grained transitions minimizes the time window for execution in privileged mode. But if fine-grained transitions happen frequently, the performance overhead associated with the transitions can become problematic.

A new annotation called PrivilegedAccess may be defined for fine-grained transitions. PrivilegedAccess may be used to tag any read, write, or function call in programs executed by the VM 106 that involve accessing shared memory areas 112. The PrivilegedAccess annotation restricts the attack surface for speculative execution attacks to an annotated set of native accesses to the shared memory areas 112. The VM 106 may insert additional instructions when the annotation PrivilegedAccess is found during compilation. These additional instructions may wrap the native access to the shared memory areas 112 within two transitions: a transition to privileged mode in the prologue of the native access and a transition to unprivileged mode in the epilogue of the native access. Because the VM 106 can only emit WRPKRU instructions in limited cases, the JIT compiler cannot be influenced to emit WRPKRU instructions that change the mode of operation.

In batched transitions, if a performance-sensitive section of trusted code includes multiple accesses to the shared memory areas 112, the associated transitions to privileged mode may be batched to minimize the performance overhead for those transitions. Sections of code in the implementation of the VM 106 may be annotated such that a temporary switch to privileged mode is performed for an entire section of code.

In some implementations, the transition mechanism may not use the WRPKRU instruction directly. Instead, a transition may use a function API provided by the DBMS 101 OS interface layer. The amount of overhead incurred per transition depends on what transition mechanism is used.

### Example VM Execution

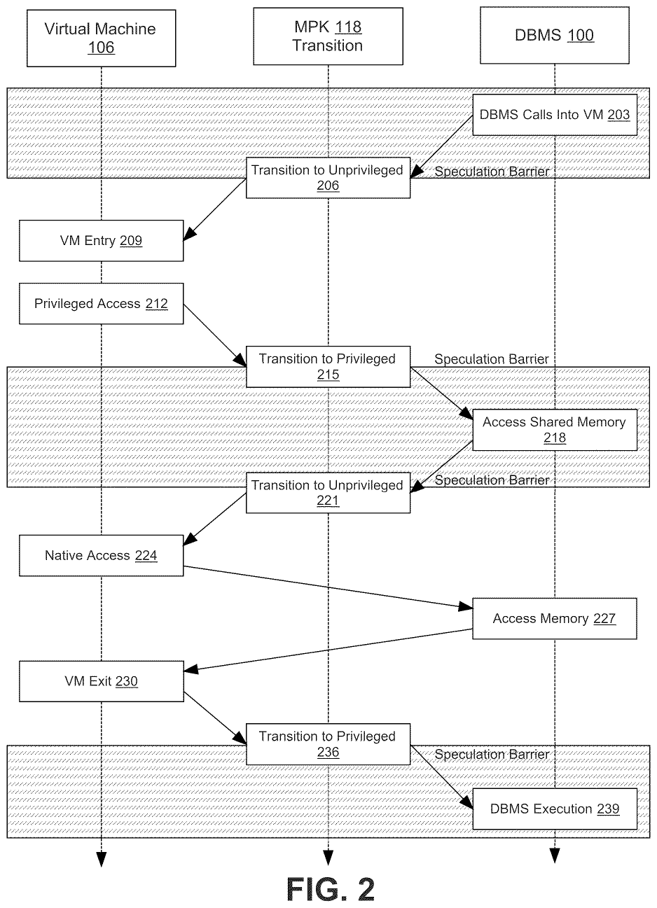

FIG. 2 is a sequence diagram showing an example of a process that takes place during the execution of a VM 106, in an embodiment. The sequence diagram of FIG. 2 provides merely an example of the many different types of functional arrangements that may be employed to implement the operation of the depicted components. As an alternative, the flow diagram of FIG. 2 may be viewed as depicting an example of elements of a method implemented within the computing environment 100.

At step 203, the DBMS 101 calls into a VM 106. This may occur, for example, when the VM 106 initiates execution of a user-defined program. A database process 105 may be created to execute the user-defined program.

At step 206, execution of the database process 105 transitions to unprivileged mode. Execution transitions to unprivileged when control flow enters the VM 106. That way, the VM 106 cannot access shared memory areas 112 unless there is a subsequent transition to privileged mode. Speculation may not occur while execution is in unprivileged mode.

At step 209, the control flow of the database process 105 enters the VM 106. The VM 106 may then begin executing the user-defined program, which can include emitting instructions to access the VM's 106 private memory area 109 or the shared memory areas 112. Because execution of the database process 105 is in unprivileged mode at the entry point into the VM 106, any attempted access to the shared memory area 112 area would be denied unless execution first transitions to privileged mode.

At step 212, the VM 106 emits an instruction that involves performing a native access of the shared memory areas 112. This instruction may be a read, write, or function call to the DBMS 101. But because execution of the database process 105 is currently in unprivileged mode, the instruction may be instrumented to cause a temporary transition of execution to privileged mode. For example, the read, write, or function call may be annotated with a Privileged Access annotation in the user-defined program, which causes a fine-grained transition to privileged mode. When the VM 106 detects the Privileged Access annotation during compilation of the user-defined program, the VM 106 may insert additional instructions into the compiled code. These additional instructions may cause a transition to privileged mode in the prologue of the native access and a transition to unprivileged mode in the epilogue of the native access.

At step 215, execution of the database process 105 transitions to privileged mode.

Execution transitions from unprivileged mode to privileged mode so that VM 106 can access the shared memory areas 112 for the annotated native access discussed in step 212. Speculation may occur while execution is in privileged mode.

At step 218, the DBMS 101 accesses the shared memory area 112 according to the instruction emitted by the VM 106 at step 212.

At step 221, execution of the database process 105 transitions to unprivileged mode. Execution transitions from unprivileged mode to privileged mode so that the VM 106 cannot access the shared memory areas 112 after the native access was completed in step 218. Speculation may again not occur when execution is in unprivileged mode.

At step 224, the VM 106 emits an instruction that involves performing a native access in the VM's 106 own private memory area 109. This instruction can be any read, write, or function call to the DBMS 101 that accesses the private memory area 109. Execution remains in unprivileged mode and does not transition to privileged mode because the shared memory areas 112 are not being accessed.

At step 227, the DBMS 101 accesses the VM's 106 private memory area 109 according to the instruction emitted by the VM 106 at step 221.

At step 230, control flow exits the VM 106. Control flow exits the VM 106 once execution of the user-defined program has terminated.

At step 233, execution of the database process 105 transitions to privileged mode. Execution transitions to privileged mode because the VM 106 is not currently executing any user-defined program and there is decreased danger of a speculative execution attack.

At step 236, execution of the DBMS 101 resumes. The DBMS 101 itself may then access the shared memory area 112. Execution may remain in privileged mode until control flow enters the VM 106 once again.

### Database Infrastructure

The DBMS 101 includes multiple database processes 105 that perform a wide range of tasks like, for example, accepting user queries, parsing and executing user queries, performing input and output operations, and cleaning up and monitoring different resources. The DBMS 101 expends resources to collaborate on tasks, synchronizing states of various shared resources, and managing available memory. The DBMS 101 uses different resources provided by the operating system, like, for example, shared memory, semaphores, and signals.

Signals help ensure the correct functioning of the DBMS 101. Signal handling procedures often involve accessing the shared memory areas. The operating system uses signals to asynchronously interrupt running database processes 105 to pass relevant information. The following are examples of signals used by the DBMS 101.

The DBMS 101 may use the SIGUSR2 signal for communicating commands to different database processes 105 in the DBMS 101. In an embodiment, SIGUSR2 may be used, for example, by an RDBMS in the Linux operating system for modifying shared objects in multiple database processes 105, performing callback actions on the occurrence of events, broadcasting shared memory projections, changing application codepath based on different ports, and performing debugging actions like dumps.

The DBMS 101 may use signals to synchronize memory mappings among database processes 105. The SIGSEGV signal indicates a segmentation fault and may be generated when a database process 105 attempts an unauthorized memory access. The SIGBUS signal indicates a bus error and may be generated when a database process 105 attempts to access an invalid memory address. The DBMS 101 may use the SIGSEGV and SIGBUS signals, for instance, to map new shared memory segments from the shared memory areas 112 among database processes 105 or to un-map old shared memory segments from database processes 105.

The DBMS 101 may use signals for exception handling. During runtime, the DBMS 101 may encounter certain errors. These errors can range from illegal memory accesses to encountering floating point exceptions. Signals may be used to handle these exceptions. For example, the SIGSEGV signal may be used to handle illegal memory accesses, while the SIGFPE signal may be used to handle floating point exceptions.

The DBMS 101 may use signals for timeouts, such as the SIGALRM signal. The SIGARLM signal is generated following the expiration of a preset timer.

The DBMS 101 may use signals for interprocess communication in MP/MT (multiple process and multiple thread) mode, such as the SIGRTMIN signal. The SIGRTMIN signal is a real-time signal that can be used to efficiently signal between database processes 105.

Other examples include using signals for generating incident dumps upon encountering fatal scenarios, for check for page read and write accesses, or to handle traps for code testing frameworks using breakpoints.

### Signal Handling With Memory Protection Keys

User-defined programs executed by the VM 106 may also be interrupted to receive signals. Applications implement signal handlers 124 to handle these signals. But signal handlers 124 may need different access permissions to the shared memory areas 112 for their execution than the user-defined programs do.

Protection policies may be used to set access permissions to the shared memory areas 112 for signal handlers 124. A protection policy specifies what PKRU value for a particular MPK 118 will be set in the PKRU register 121. Because the PKRU register 121 is thread-local, these protection policies may be tracked in thread-local storage.

When a database process 105 is interrupted by a signal, the default behavior of MPKs 118 may be to assign a new, default protection policy to the signal handler 124 that overrides the protection policy of the interrupted database process 105. The default protection policy for signal handlers 124 may be to disallow all read or write accesses to the shared memory areas 112, irrespective of the protection policy specified outside the signal handler 124 context (that is, for all MPKs 118 except the default key 0, which is not available for applications to use).

This default protection policy may be used for signal handlers 124 because the operating system kernel uses the hardware mechanism XSAVE to manage the PKRU register 121. XSAVE is an instruction in the x86 architecture that is used to save extended CPU states like that of the PKRU register 121. XSAVE is used to save the state of the PKRU register 121 when a signal interrupts a database process 105 and control flow enters the signal handler 124 context. But this interruption leads to the disruption of many DBMS 101 functionalities that involve MPKs 118.

Thus, the implementation of MPKs in the DBMS 101 involves manipulating the PKRU register 121 from within a signal handler 124. To preserve the signal functionalities discussed above, the DBMS 101 may implement different behavior for different signals.

### Signal Handlers Accessing Shared Memory for Critical Tasks

Some signal handlers 124 may require read-write access to the shared memory areas 112 for critical tasks. Such signal handlers 124 may include, for example, signal handlers 124 used for tasks like performing dumps and passing commands to processes, dumping on crashes, and exception handling. The protection policies for signal handlers 124 handling such critical tasks may specify that the PKRU register 121 be written to read-write protection for the MPK 118 within the respective signal handlers 124. Doing so may ensure expected behavior for those signal handlers 124, such as the SIGUSR2 signal handler 124. When control flow enters such a signal handler 124, the PKRU register 121 may be written to read-write protection for the corresponding MPK 118.

### Signal Handlers Accessing Shared Memory for Non-Critical Tasks

For signal handlers 124 accessing the shared memory areas for non-critical tasks, the VM 106 (or other client) may specify a protection policy to be used when entering those signal handlers 124. The VM 106 may specify that the protection policy in such signal handlers 124 be read-only, read-write, no-access, or the protection policy from the interrupted context. Because the PKRU register 121 is thread-local, these protection policies may be tracked in thread-local storage.

In some implementations, a PKRU value may be written to the PKRU register 121 at a common entry point for one or more of the signals of the DBMS 101. Doing so ensures the proper functioning of applications implementing signal handlers 124 with respect to MPKs 118. In some examples, writing a protection value at that entry point ensures memory protection for signal handlers 124 like the signal handler 124 for the SIGALRM signal, for instance.

### Signal Handling With Longjmp

The setjmp and longjmp instructions allow a user to save stack context in a jump buffer and later restore the stack context. The stack context includes the state of the call stack at a given point, where the call stack is a data structure used by the operating system to store information about function calls, control flow, and other context of a database process 105. The setjmp instruction saves, in the jump buffer, the current stack context of the database process 105. The longjmp instruction may restore the stack context saved in the jump buffer by the setjmp instruction and return control flow to a point in the database process 105 corresponding to the setjmp instruction and continue execution of the database process 105.

The setjmp and longjmp instructions may be used for exception handling. When a signal handler 124 handles an exception, the setjmp and longjmp instructions may be used to avoid returning control flow to a point in a database process 105 that caused the exception. For example, a segment violation signal handler 124 may handle a segment violation and then use the longjmp instruction to resume execution of the database process 105 from a previous stack context saved by the setjmp instruction. As another example, an alarm signal handler 124 may prevent the database process 105 from waiting indefinitely on a semaphore by saving stack context using the setjmp instruction and, once an alarm signal is received after a certain wait time, using the longjmp instruction to restore that stack context, before the wait began.

But conventional implementations of the jump buffer do not save the state of the PKRU register 121 when the setjmp instruction is used. Thus, following the invocation of the longjmp instruction, the PKRU value at the time the execution of the database process 105 is resumed would remain the same as the PKRU value in the signal handler 124 context from before the longjmp instruction. This leads to a no-access protection policy for the MPK 118 outside the signal handler 124 context.

To address this issue, the PKRU register 121 may be written to a “runtime” PKRU value. The runtime PKRU value represents the protection policy associated with execution of a database process 105 outside of a signal handler 124. The runtime PKRU value may be maintained in thread-local storage. Before the longjmp instruction is used to jump control flow out of a signal handler 124, the PKRU register 121 may be written to the runtime PKRU value. Doing so ensures proper behavior of the database process 105 outside of the signal handler 124 once normal execution resumes.

### Signal Handling With In-Database Virtual Machine

In some implementations, the VM 106 does not manage any aspects of signal handling logic. When a signal is being handled, however, the VM 106 may still need to execute some code. One example of such a situation is during diagnostics dumping, when system or application context information is saved following an error. If a fatal, non-recoverable error has occurred, then transitions between non-privileged mode and privileged mode may be disabled altogether. If a non-fatal error has occurred, accesses to the shared memory areas 112 using the PrivilegedAccess annotation may still be allowed, and so transitions between non-privileged mode and privileged mode may remain enabled.

### Example Process for Signal Handling

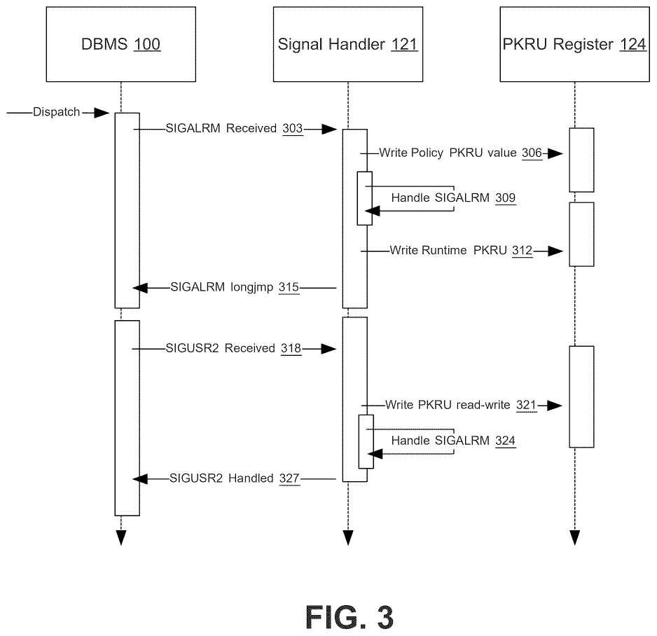

FIG. 3 is a sequence diagram that depicts an example process for signal handling with the VM 106. The sequence diagram of FIG. 3 provides merely an example of the many different types of functional arrangements that may be employed to implement the operation of the depicted components. As an alternative, the sequence diagram of FIG. 3 may be viewed as depicting an example of elements of a method implemented within the computing environment 100.

At step 303, a signal handler 124 receives a SIGALRM signal from the DBMS 101. The DBMS 101 may issue the SIGALRM signal following the generation of a preset timer. The DBMS 101 issuing the SIGALRM signal may interrupt a currently executing database process 105. The setjmp instruction may be used to save the stack context of the database process 105 to a jump buffer. The saved stack context includes information about the state of the call stack at the time the setjmp instruction was invoked. The signal handler 124 may execute within that same database process 105; normal execution of the database process 105 is paused, and control flow is switched to the signal handler 124.

At step 306, the signal handler 124 writes a policy PKRU value to the PKRU register 121. The policy PKRU value indicates what access permissions the signal handler 124 has to the shared memory areas 112. Unless the signal handler 124 needs to access the shared memory areas 112 for a critical task, the policy PKRU value may be dictated by a protection policy maintained by the VM 106. The protection policy may specify that the signal handler 124 has read-only access to the shared memory areas 112, read-write access to the shared memory areas 112, or no access to the shared memory areas 112; or the protection policy may specify that the signal handler 124 retains the same access permissions as the context that was interrupted when the DBMS 101 issued the SIGALRM signal. The protection policy may be tracked in thread-local storage.

At step 309, the signal handler 124 handles the SIGALRM signal. The signal handler 124 may, for example, log that the alarm was received, exit from a wait or other blocking operation, or set a flag, depending on the implementation.

At step 312, the signal handler 124 writes a runtime PKRU value to the PKRU register 121. Once the SIGALRM signal is handled, control flow will exit the signal handler 124 context and re-enter the context that was interrupted by the SIGALRM signal. Thus, the runtime PKRU value is written to the PKRU register 121 so that the protection policy associated with the runtime context will be in place once control flow re-enters the interrupted context. The runtime PKRU value may be maintained in thread-local storage.

At step 315, the signal handler 124 issues a SIGALRM longjmp instruction. The longjmp instruction may restore the stack context from the interrupted context. This stack context was saved to the jump buffer by the setjmp instruction. The longjmp instruction thereby returns control flow to the interrupted context, which may be the database process 105 as it was executing when the setjmp instruction was invoked. Execution may be resumed at a point before the SIGALRM signal was triggered to avoid doing so again.

At step 318, the signal handler 124 receives a SIGUSR2 signal from the DBMS 101. The SIGUSR2 signal may be generated, for example, via the operating system to trigger a process state dump, which provides information about the currently executing database process 105. The SIGUSR2 may therefore be useful for investigating issues related to the database process 105.

At step 321, the signal handler 124 writes the PKRU register 121 to read-write protection. The read-write PKRU value may be written to the PKRU register 121 when handling the SIGUSR2 signal involves accessing the shared memory areas 112 for a critical task. The read-write PKRU value is written to the PKRU register 121 instead of a PKRU value dictated by a protection policy to ensure expected behavior of the signal handler 124.

At step 324, the signal handler 124 handles the SIGUSR2 signal. Handling the SIGUSR2 signal may involve, for example, performing dumps and passing commands to processes, dumping on crashes, or exception handling, depending on the implementation. These tasks in turn involve read-write access to the shared memory areas 112.

At step 327, the signal handler 124 indicates to the DBMS 101 that the SIGUSR2 signal has been handled, and the PKRU context is restored by the operating system kernel. That way, the DBMS 101 may resume normal execution of the database process 105.

### DBMS Overview

A DBMS manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MongoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes 105. Database processes 105 run under the control of the database server (i.e. can be created or terminated by the database server) and perform various database server functions. Database processes 105 include processes running within a database session established for a client.

A database process 105 is a unit of execution. A database process 105 can be a computer system process or thread or a user-defined execution context such as a user thread or fiber. Database processes 105 may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

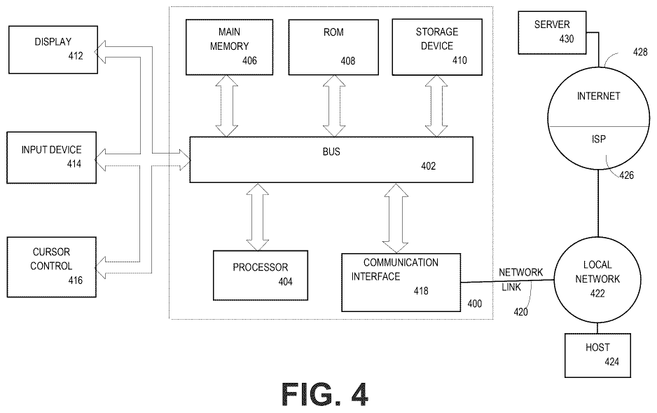

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

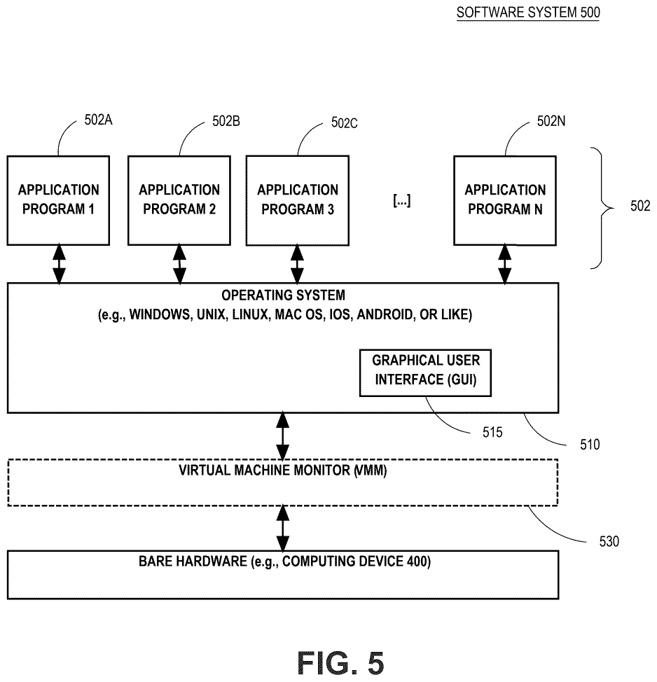

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

What is claimed is:

1. A method comprising:
associating at least a portion of a shared memory area with a memory protection key;
initiating, via a virtual machine (VM) embedded in a database process of a database management system (DBMS), execution of a user program;
causing execution of the database process to transition to a privileged mode, the privileged mode enabling access to the at least a portion of the shared memory area by the VM;
accessing, via the VM, the at least a portion of the shared memory area; and
causing the execution of the database process to transition to an unprivileged mode, the unprivileged mode disabling access to the shared memory area by the VM,
wherein the method is performed by one or more computing devices.

2. The method of claim 1, wherein the DBMS is a multi-tenant DBMS, and the VM is associated with one of a plurality of tenants.

3. The method of claim 1, wherein the at least a portion of shared memory is tagged with the memory protection key during an initialization of the DBMS.

4. The method of claim 1, wherein causing the execution of the database transition to a privileged mode comprises modifying values of a pair of bits in a public key rights register for user pages.

5. The method of claim 1, wherein the at least a portion of the shared memory comprises data from a database associated with the VM.

6. The method of claim 1, wherein execution of the database process transitions to the privileged mode in response to an annotation associated with a native access of the shared memory areas in the user program.

7. The method of claim 6, further comprising inserting a plurality of additional instructions in a compilation of the user program, wherein the plurality of additional instructions comprises a first instruction to transition the execution of the database process to privileged mode in a prologue of the native access and a second instruction to transition the execution of the database process to unprivileged mode in an epilogue of the native access.

8. The method of claim 1, wherein execution of the database process transitions to the privileged mode in response to an annotation associated with a plurality of batched accesses to the shared memory area.

9. A method comprising:
a signal handler receiving a signal from a database management system (DBMS), wherein the signal interrupts a virtual machine (VM) executing a user program in a database process, and the signal handler executes in the database process;
the signal handler writing, to a protection key rights register for user pages (PKRU register), a particular PKRU value, wherein the particular PKRU value is associated with a particular access permission to a shared memory area of the DBMS;
the signal handler handling the signal; and
the signal handler writing, to the PKRU register, a runtime PKRU value, wherein the runtime PKRU value is associated with a runtime access permission to the shared memory area,
wherein the method is performed by one or more computing devices.

10. The method of claim 9, wherein the particular access permission is a read-write access permission.

11. The method of claim 9, wherein the particular access permission is specified by a protection policy associated with the signal handler.

12. The method of claim 9, wherein the runtime access permission comprises an access permission associated with a context of the VM executing the user program in the database process.

13. The method of claim 9, further comprising the signal handler executing a longjmp instruction, wherein the longjmp instruction causes a restoration of a stack context associated with the VM executing the user program in the database process.

14. The method of claim 13, wherein a setjmp instruction caused the stack context to be saved to a jump buffer.

15. One or more non-transitory storage media storing instructions which, when executed by one or more computing devices, cause:
associating at least a portion of a shared memory area with a memory protection key;
initiating, via a virtual machine (VM) embedded in a database process of a database management system (DBMS), execution of a user program;
causing execution of the database process to transition to a privileged mode, the privileged mode enabling access to the at least a portion of the shared memory area by the VM;
accessing, via the VM, the at least a portion of the shared memory area; and
causing the execution of the database process to transition to an unprivileged mode, the unprivileged mode disabling access to the shared memory area by the VM,
wherein the method is performed by one or more computing devices.

16. The one or more non-transitory storage media of claim 14, wherein the DBMS is a multi-tenant DBMS, and the VM is associated with one of a plurality of tenants.

17. The one or more non-transitory storage media of claim 14, wherein the at least a portion of shared memory is tagged with the memory protection key during an initialization of the DBMS.

18. The one or more non-transitory storage media of claim 14, wherein causing the execution of the database transition to a privileged mode comprises modifying values of a pair of bits in a public key rights register for user pages.

19. The one or more non-transitory storage media of claim 14, wherein the at least a portion of the shared memory comprises data from a database associated with the VM.

20. The one or more non-transitory storage media of claim 14, wherein execution of the database process transitions to the privileged mode in response to an annotation associated with a native access of the shared memory areas in the user program.

21. The one or more non-transitory storage media of claim 19, further comprising inserting a plurality of additional instructions in a compilation of the user program, wherein the plurality of additional instructions comprises a first instruction to transition the execution of the database process to privileged mode in a prologue of the native access and a second instruction to transition the execution of the database process to unprivileged mode in an epilogue of the native access.

22. The one or more non-transitory storage media of claim 14, wherein execution of the database process transitions to the privileged mode in response to an annotation associated with a plurality of batched accesses to the shared memory area.

23. One or more non-transitory storage media storing instructions which, when executed by one or more computing devices, cause:
a signal handler receiving a signal from a database management system (DBMS), wherein the signal interrupts a virtual machine (VM) executing a user program in a database process, and the signal handler executes in the database process;
the signal handler writing, to a protection key rights register for user pages (PKRU register), a particular PKRU value, wherein the particular PKRU value is associated with a particular access permission to a shared memory area of the DBMS;
the signal handler handling the signal; and
the signal handler writing, to the PKRU register, a runtime PKRU value, wherein the runtime PKRU value is associated with a runtime access permission to the shared memory area,
wherein the method is performed by one or more computing devices.

24. The one or more non-transitory storage media of claim 22, wherein the particular access permission is a read-write access permission.

25. The one or more non-transitory storage media of claim 22, wherein the particular access permission is specified by a protection policy associated with the signal handler.

26. The one or more non-transitory storage media of claim 22, wherein the runtime access permission comprises an access permission associated with a context of the VM executing the user program in the database process.

27. The one or more non-transitory storage media of claim 22, further comprising the signal handler executing a longjmp instruction, wherein the longjmp instruction causes a restoration of a stack context associated with the VM executing the user program in the database process.
